(19) United States
(12) Patent Application Publication
(10) Pub. No.: US 2010/0183945 A1
(43) Pub. Date: Jul. 22, 2010

(54) ELECTRODE CATALYST FOR FUEL CELL, PROCESS FOR PRODUCING THE SAME AND SOLID POLYMER FUEL CELL COMPRISING THE SAME

(76) Inventor: Sreekumar Kurungot, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/088,024

(22) PCT Filed: Mar. 1, 2007
(86) PCT No.: PCT/JP2007/054488

§ 371 Date: Mar. 25, 2008

(30) Foreign Application Priority Data
Mar. 6, 2006 (JP) 2006-059522

(51) Int. Cl. H01M 8/10; H01M 4/88

(52) U.S. Cl. 429/485; 502/101; 977/700; 977/734

(57) ABSTRACT

To improve catalytic efficiency by securing sufficient three phase interfaces in carbon nanohorns, where a reactant gas, a catalyst and an electrolyte meet. The resulting support with a catalyst allows an electrode reaction to proceed efficiently and improves the power generation efficiency of a fuel cell. Also, an electrode having excellent properties and a solid polymer fuel cell including the electrode, capable of giving high battery output are provided. An electrode catalyst for a fuel cell including a carbon nanohorn aggregate as a support, a catalytic metal supported on the carbon nanohorn aggregate support and a polyelectrolyte applied to the carbon nanohorn aggregate support, characterized in that the catalytic metal is not supported in deep regions between carbon nanohorns. Preferably, the catalytic metal has an average particle size of 3.2 to 4.6 nm.

### TECHNICAL FIELD

The present invention relates to an electrode for a fuel cell, a process for producing the same and a solid polymer fuel cell comprising the same.

### BACKGROUND ART

Solid polymer fuel cells containing a polyelectrolyte film are expected to be practically used as power sources for mobile vehicles such as electric cars and for small cogeneration systems since making them small and lightweight is easy.

The electrode reaction in each catalyst layer of an anode and a cathode of a solid polymer fuel cell proceeds at a three phase interface (hereinafter reaction site) where a reaction gas, a catalyst and a fluorine-containing ion exchange resin (electrolyte) coexist. Thus, in solid polymer fuel cells, a catalyst such as metal-supporting carbon in which a catalytic metal such as platinum is supported on a carbon black support having a large specific surface area is coated with a fluorine-containing ion exchange resin of the same or different type from the polyelectrolyte film, and the resultant is used as a material constituting the catalyst layer.

As described above, protons and electrons are produced in an anode in the coexistence of three phases of a catalyst, carbon particles and an electrolyte. Specifically, hydrogen gas is reduced in the coexistence of an electrolyte through which protons are transferred, carbon particles through which electrons are transferred, and further, a catalyst. Therefore, the larger the amount of catalyst supported on carbon particles, the higher the power generation efficiency. The same applies to cathodes. However, since precious metal such as platinum is used as a catalyst for a fuel cell, a larger amount of catalyst supported on carbon particles involves a problem that the cost of manufacturing fuel cells increases.

In a conventional method of preparing a catalyst layer, ink obtained by dispersing an electrolyte such as Nafion® and catalyst powder such as platinum/carbon in a solvent is cast and dried. It is assumed that while the catalyst powder penetrates deep into the pores of a carbon support since the powder has a size of several nanometers to several tens of nanometers, an electrolyte polymer cannot enter into the nanosize pores because the polymer molecules are large and aggregated, and the polymer only covers the catalyst surface. For this reason, platinum in the pores is not fully brought into contact with the electrolyte polymer and cannot be effectively used, causing decrease in the catalytic ability.

To cope with the problem, JP Patent Publication (Kokai) No. 2002-373662 A aims at improving power generation efficiency without increasing the amount of catalyst supported on carbon particles, and discloses a method of producing an electrode for a fuel cell, comprising treating an electrode paste obtained by mixing catalyst-supporting particles in which catalyst particles are supported on the surface with an ion conducting polymer with a solution containing catalytic metal ions, thereby subjecting the catalytic metal ions to ion substitution to form an ion conducting polymer, and then reducing the catalytic metal ions.

On the other hand, International Publication No. WO2002/075831 aims at improving utilization efficiency of a catalyst electrode for a fuel cell, and discloses a solid polyelectrolyte-catalyst complex electrode comprising a solid polyelectrolyte and carbon fine particles on which a catalytic substance is supported, which is an electrode for a solid polymer fuel cell using, as carbon particles, single layer carbon nanohorn aggregates which are spherically aggregated single layer carbon nanohorns composed of single layer carbon nanotubes having a specific structure in which one end is conical, and a solid polymer fuel cell using the same.

Also, JP Patent Publication (Kokai) 2004-152489 A aims at improving utilization efficiency of a catalyst for a catalyst electrode for a fuel cell, and discloses an invention in which a carbon nanohorn aggregate is used as a carbon material for a catalyst layer of a catalyst carrier carbon particle, a solution of a metallic salt and the carbon nanohorn aggregate are mixed, a reducing agent is added thereto, the mixture is stirred so that the catalytic metal is supported on the carbon nanohorn aggregate surface, then reducing treatment is performed at a low temperature to control the particle size of the catalytic metal.

### DISCLOSURE OF THE INVENTION

However, even treatment as in JP Patent Publication (Kokai) No. 2002-373662 A is performed, improvement in the power generation efficiency is limited. This is because catalyst-supporting carbon has nanoscale pores into which polyelectrolyte which is a polymer aggregate cannot enter, and a catalyst such as platinum adsorbed to deep regions of the pores is not capable of forming a three phase interface, i.e., a reaction site described above. As herein described, the problem is that electrolyte polymers cannot enter into carbon pores.

Also, although a carbon nanohorn aggregate is used as a carbon support in the method of International Publication No. WO2002/075831, there are narrow spaces between carbon nanohorns in the carbon nanohorn aggregate, and once a catalyst such as platinum is adsorbed to the deep regions, polyelectrolyte, which is a polymer aggregate, cannot enter into the site. Thus, three phase interfaces (reaction sites) cannot be sufficiently formed and improvement in the power generation efficiency is not satisfactory.

The method of JP Patent Publication (Kokai) No. 2004-152489 A is for controlling the particle size of catalytic metal supported on the carbon nanohorn aggregate surface, and the publication describes that the average particle size of the catalytic metal is set to 5 nm or less. However, the publication describes that “the catalytic material has an average particle size of 5 nm or less, more preferably 2 nm or less. This makes it possible to further reduce the specific surface area of the catalytic material. Accordingly, the catalytic efficiency when used in a fuel cell increases and the output of the fuel cell can be further improved. Although the lower limit is not particularly limited, the average particle size is, for example, 0.1 nm or more, preferably 0.5 nm or more. This makes it possible to produce an electrode having good catalytic efficiency with high production stability”. The description suggests that the smaller the average particle size of the catalytic material, the better. The publication also describes that “in order to improve properties of a fuel cell, the surface area of the catalytic material must be increased to improve catalytic activity at a catalytic electrode. To this end, it is necessary that the particle size of catalyst particles is reduced and the particles are uniformly dispersed.” In fact, in Examples, platinum particles having an average particle size of 1 to 2 nm are used.

Studies conducted by the present inventors have revealed that when platinum particles having an average particle size of 1 to 2 nm or less are used, as in the case of International Publication No. WO2002/075831, a catalyst such as platinum is adsorbed to deep regions in narrow spaces between carbon nanohorns of a carbon nanohorn aggregate, and polyelectrolyte, which is a polymer aggregate, cannot enter into the site, and therefore three phase interfaces (reaction sites) cannot be sufficiently formed and improvement in the power generation efficiency is not satisfactory.

As described above, even though the objects of the inventions of JP Patent Publication (Kokai) No. 2002-373662 A, International Publication No. WO2002/075831 and JP Patent Publication (Kokai) No. 2004-152489 A are to facilitate formation of three phase interfaces (reaction sites), the results are insufficient and improvement in the power generation efficiency is also not satisfactory.

The present invention has been made in view of the above problems of prior art. An object of the present invention is to improve catalytic efficiency by securing sufficient three phase interfaces in carbon nanohorns, where a reactant gas, a catalyst and an electrolyte meet. Another object is to enable efficient progress of an electrode reaction by the above improvement, and to improve the power generation efficiency of a fuel cell. Still another object of the present invention is to provide an electrode having excellent properties and a solid polymer fuel cell comprising the electrode, capable of giving high battery output.

The present inventors have focused on the average particle size of a catalytic metal of an electrode catalyst for a fuel cell, and contrary to the technical knowledge of this field, they have found that sufficient three phase interfaces where a reaction gas, a catalyst and an electrolyte meet can be secured by increasing the average particle size of the catalytic metal, whereby the catalytic efficiency can be improved, and the present invention has been made.

Accordingly, first, the present invention relates to an electrode catalyst for a fuel cell, comprising a carbon nanohorn (CNH) aggregate as a support, a catalytic metal supported on the carbon nanohorn aggregate support and a polyelectrolyte applied to the carbon nanohorn aggregate support, characterized in that the catalytic metal is not supported in deep regions between carbon nanohorns. Since the catalytic metal is not supported in deep regions between carbon nanohorns, in other words, the catalytic metal is supported on the surface of the tips and middle portions of the carbon nanohorns, sufficient three phase interfaces where a reaction gas, a catalyst and an electrolyte meet can be secured at those sites, enabling improvement in the catalytic efficiency.

In the electrode catalyst for a fuel cell of the present invention, the state that “the catalytic metal is not supported in deep regions between carbon nanohorns” can be achieved by setting the average particle size of the catalytic metal to 3.2 to 4.6 nm. Setting the average particle size of the catalytic metal sufficiently larger than spaces between carbon nanohorns prevents the catalytic metal from entering into and supported on deep regions between carbon nanohorns.

Second, the present invention relates to a process for producing the above electrode catalyst for a fuel cell, comprising a carbon nanohorn aggregate as a support, a catalytic metal supported on the carbon nanohorn aggregate support and a polyelectrolyte applied to the carbon nanohorn aggregate support, the process comprising the steps of dispersing a salt of the catalytic metal in a solvent, adding the carbon nanohorn aggregate thereto, reducing, filtering and drying the mixture under heating, and applying the polyelectrolyte to the resulting catalytic metal-supporting carbon nanohorn aggregate.

In the process for producing an electrode catalyst for a fuel cell of the present invention, the catalytic metal has an average particle size of preferably 3.2 to 4.6 nm as described above.

Specifically, the average particle size of the catalytic metal can be set to 3.2 to 4.6 nm by controlling (1) the supporting ratio of the catalytic metal supported on the carbon nanohorn aggregate, (2) the reduction temperature, (3) the reduction time, or (4) combining two or more of these.

More specifically, preferably (1) the supporting ratio of the catalytic metal supported on the carbon nanohorn aggregate is 45 to 70%, (2) the reduction temperature is 130 to 180° C. and (3) the reduction time is 8 to 16 hours.

Further, in the present invention, to facilitate supporting of the catalytic metal on the carbon nanohorn aggregate support and application of the polyelectrolyte, preferably the carbon nanohorn aggregate is pretreated with a hydrogen peroxide solution.

Third, the present invention relates to a solid polymer fuel cell comprising an anode, a cathode and a polyelectrolyte film disposed between the anode and the cathode, characterized in that the anode and/or the cathode comprise the electrode catalyst for a fuel cell.

As described above, with the aforementioned electrode according to the present invention having high catalytic efficiency and excellent power generation properties, a solid polymer fuel cell having high battery output can be formed. Also, as described above, since the electrode according to the present invention has high catalytic efficiency and is excellent in durability, the solid polymer fuel cell of the present invention comprising the electrode is capable of providing a high, stable battery output over a long period.

The electrode catalyst for a fuel cell of the present invention, in which the utilization rate of the catalyst is improved, is an electrode catalyst for a fuel cell, comprising a polyelectrolyte, a carbon nanohorn aggregate and a catalytic metal. In the electrode, little catalytic metal is present in deep spaces between carbon nanohorns, and therefore sufficient three phase interfaces can be formed at the surface of the tips and middle portions of the carbon nanohorns, and a small amount of catalytic metal can be efficiently used for the reaction. As herein described, the utilization rate of the catalyst increases and the power generation efficiency is improved even if the amounts of materials are the same.

### BRIEF DESCRIPTION OF THE DRAWINGS

FIG. 1 is a schematic view of a support with a catalyst according to the present invention, comprising a carbon nanohorn aggregate 1 on which a catalytic metal 2 is supported and a polyelectrolyte 3;

FIG. 2 is a schematic view of a conventional support with a catalyst, comprising a carbon nanohorn aggregate 1 on which a catalytic metal 2 is supported and a polyelectrolyte 3;

FIG. 3 is a schematic view of the pretreatment of carbon nanohorn aggregates with a hydrogen peroxide solution and a polyol process by ethylene glycol following the pretreatment;

FIG. 4 is a TEM photograph of the support with a catalyst obtained in Example 1;

FIG. 5 is a TEM photograph of the support with a catalyst obtained in Example 2;

FIG. 6 is a TEM photograph of the support with a catalyst obtained in Example 3;

FIG. 7 illustrates the relationship between average particle sizes of Pt and active Pt areas of the supports with a catalyst obtained in Examples 1 to 3; and

FIG. 8 illustrates the relationship between average particle sizes of Pt and O₂ reduction currents of the supports with a catalyst obtained in Examples 1 to 3.

### DESCRIPTION OF SYMBOLS

1: carbon nanohorn aggregate
2: catalytic metal
3: polyelectrolyte
4: deep regions between carbon nanohorns

### BEST MODE FOR CARRYING OUT THE INVENTION

In the following, the present invention is described using schematic views of the electrode catalyst for a fuel cell of the present invention and a conventional one.

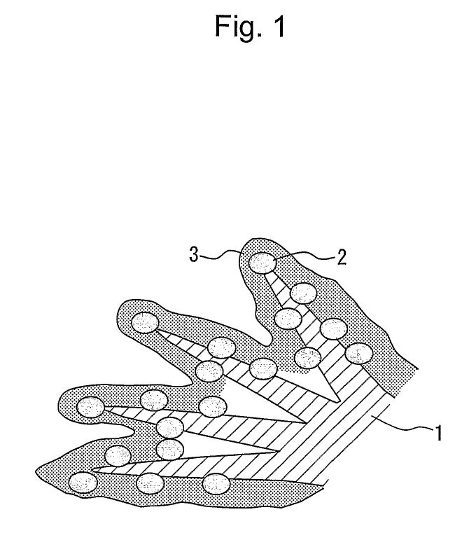

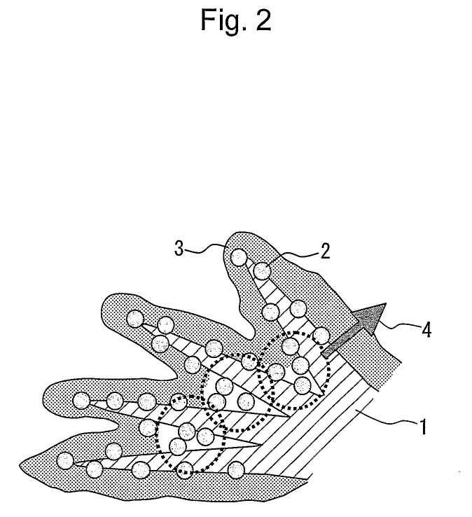

As shown in FIG. 1 and FIG. 2, the “carbon nanohorn aggregate” on which the catalytic metal is supported is a spherical aggregate of carbon nanohorns which are carbon isotopes composed only of carbon atoms. The term “spherical” in this case does not necessarily mean completely spherical, but includes various aggregates such as elliptical and doughnut-shaped ones.

FIG. 1 illustrates a support with a catalyst according to the present invention composed of, for example, a carbon nanohorn aggregate 1 on which a catalytic metal 2 such as platinum is supported and a polyelectrolyte 3, typically, Nafion®. The greatest characteristic is that relatively large particles of the catalytic metal 2 are supported on the surface of the tips and middle portions of the carbon nanohorn aggregate 1 and the catalytic metal 2 is not supported in deep regions between carbon nanohorns. At the same time, a thin polyelectrolyte 3 is uniformly present on the surface and in the pores of the carbon nanohorn aggregate 1. Such configuration makes it possible to secure sufficient three phase interfaces in the carbon nanohorn aggregate 1, where a reactant gas, the catalytic metal 2 and the polyelectrolyte 3 meet and improve catalytic efficiency.

On the other hand, FIG. 2 illustrates a conventional support with a catalyst composed of, for example, a carbon nanohorn aggregate 1 on which a catalytic metal 2 such as platinum is supported and a polyelectrolyte 3, typically, Nafion®. Compared to FIG. 1, the catalytic metal 2 has a smaller particle size, and is supported even in deep regions 4 between carbon nanohorns constituting the carbon nanohorn aggregate 1. Little polyelectrolyte 3 is present in the deep regions 4 between carbon nanohorns. Because of this, although the catalytic metal 2 is present in the carbon nanohorn aggregate 1, the three phase interface where a reaction gas, the catalytic metal 2 and the polyelectrolyte 3 meet is not present in some area, lowering the catalytic efficiency.

In the conventional method of FIG. 2, a polyelectrolyte such as Nafion® is dispersed in the carbon nanohorn aggregate in the form of a polymer. At the same time, catalytic metal particles having an extremely small size of a few molecules, i.e., a particle size of 2 to 3 nm, are supported on the carbon nanohorn aggregate having an extremely large specific surface area even in deep regions between carbon nanohorns. Therefore, substances such as polyelectrolyte having a molecular weight of thousands to tens of thousands cannot enter into deep regions between carbon nanohorns, and most of the catalytic metal supported in deep regions between carbon nanohorns do not come into contact with the electrolyte, failing to contribute to the reaction. Conventionally, the utilization rate of catalytic metal supported on carbon nanohorn aggregates is only about 10%, and improvement in the utilization rate has been a longstanding problem for catalytic systems using an expensive catalyst such as platinum.

For the carbon nanohorn (CNH) used as a support in the electrode catalyst for a fuel cell of the present invention, a carbon nanohorn aggregate, which is a spherical aggregate of carbon nanohorns, is used. The term “spherical” in this case does not necessarily mean completely spherical, but includes various aggregates such as elliptical and doughnut-shaped ones.

The carbon nanohorn aggregate is a tubular material which is a carbon nanotube having a conical end. The conical parts are aggregated by Van der Waals' force working between them and projected to the surface like horns from the tube. The carbon nanohorn aggregate has a diameter of 120 nm or less, typically 10 nm to 100 nm.

The tube of carbon nanohorns constituting the carbon nanohorn aggregate has a diameter of about 2 nm and a length of typically 30 nm to 50 nm. The conical part has a conical angle at the axial plane of about 20° on average. With such a characteristic structure, the carbon nanohorn aggregate has a packing structure with an extremely large specific surface area.

The carbon nanohorn aggregate can be generally produced by a laser ablation method using a single substance of carbon in a solid state, such as graphite, as a target at room temperature in an inert gas atmosphere of 1.01325×105 Pa. Also, the size of pores among spherical particles in the carbon nanohorn aggregate can be controlled by the conditions in the production by the laser ablation method or oxidation treatment after the production. At the center of the carbon nanohorn aggregate, carbon nanohorns may be chemically bonded or carbon nanotubes may be curled up like a ball, but the aggregate is not limited by such central structures. Alternatively, aggregates having a hollow center are also available.

One end, which is the tip, of carbon nanohorns constituting the carbon nanohorn aggregate may be closed or opened. Also, the tip of the conical end may be rounded. When the tip of the conical end of carbon nanohorns constituting the carbon nanohorn aggregate is rounded, the carbon nanohorns are radially aggregated with the rounded tips facing outward. Part of the structure of the carbon nanohorns may be irregular or has micropores. In addition, the carbon nanohorn aggregate may also contain a carbon nanotube in part.

The carbon nanohorn aggregate can be a single layer carbon nanohorn. This can improve the hydrogen ion conductivity in the carbon nanohorn aggregate. Alternatively, the carbon nanohorn aggregate can be a single layer carbon nanohorn aggregate composed of single layer graphite nanohorns. This improves the electric conductivity of the carbon nanohorn aggregate, and therefore when the aggregate is used for a catalyst electrode for a fuel cell, properties of the catalyst electrode can be improved.

As the catalytic metal supported on a support in the electrode catalyst for a fuel cell of the present invention, the following substances, for example, can be used. Examples of catalysts for the anode include platinum, rhodium, palladium, iridium, osmium, ruthenium, rhenium, gold, silver, nickel, cobalt, lithium, lanthanum, strontium and yttrium. These may be used alone or in combination of two or more. For the catalyst for the cathode, the same substances as the' catalysts for the anode, which are listed above, can be used. The same or different catalyst may be used for the anode and the cathode.

The polyelectrolyte used in the electrode catalyst for a fuel cell of the present invention has a role of electrically connecting the carbon nanohorn aggregate on which the catalytic metal is supported and a solid electrolyte film on the surface of the catalyst electrode, and allowing the fuel to reach the surface of the catalytic metal, and must have hydrogen ion conductivity. Moreover, when an organic liquid fuel such as methanol is fed to the anode, the polyelectrolyte needs to have fuel permeability and oxygen permeability in the cathode. To satisfy such requirements, a material having excellent hydrogen ion conductivity and excellent permeability of organic liquid fuel such as methanol is preferably used for the polyelectrolyte. Specifically, an organic polymer containing a polar group such as a strong acid group including a sulfone group and a phosphate group or a weak acid group including a carboxyl group is preferably used. Examples of such organic polymers include sulfone group-containing perfluorocarbon (Nafion available from DuPont, Aciplex available from Asahi Kasei Corporation), carboxyl group-containing perfluorocarbon (Flemion S film available from ASAHI GLASS CO., LTD.), polystyrene sulfonic acid copolymers, polyvinylsulfonic acid copolymers, crosslinked alkylsulfonic acid derivatives, copolymers such as fluorine-containing polymers composed of a fluorine resin skeleton and sulfonic acid and copolymers obtained by copolymerization of acrylamide such as acrylamide-2-methylpropane sulfonic acid and acrylate such as n-butyl methacrylate.

Also, organic polymers having a polar group such as a strong acid group or a weak acid group described above can be used as the polyelectrolyte. For polymers to which the polar group is bonded, resins containing nitrogen or a hydroxyl group such as polybenzimidazole derivatives, polybenzoxazole derivatives, crosslinked polyethyleneimine, polysilamine derivatives, amine-substituted polystyrene such as polydiethylaminoethyl polystyrene and nitrogen-substituted polyacrylate such as diethylaminoethyl polymethacrylate, hydroxyl group-containing polyacrylic resins such as silanol-containing polysiloxane and hydroxyethyl polymethyl acrylate and hydroxyl group-containing polystyrene resins such as parahydroxypolystyrene may also be used.

Also, a crosslinkable substituent such as a vinyl group, an epoxy group, an acrylic group, a methacrylic group, a cinnamoyl group, a methylol group, an azido group or a naphthoquinonediazido group may be accordingly introduced into the above polymers.

The polyelectrolyte may be the same or different in the fuel electrode and the oxidant electrode.

In the present invention, in view of the utilization efficiency of catalysts, the ratio of the weight of the polyelectrolyte to the total weight of the polyelectrolyte and the carbon nanohorn aggregate on which the catalyst is supported is preferably less than 10%.

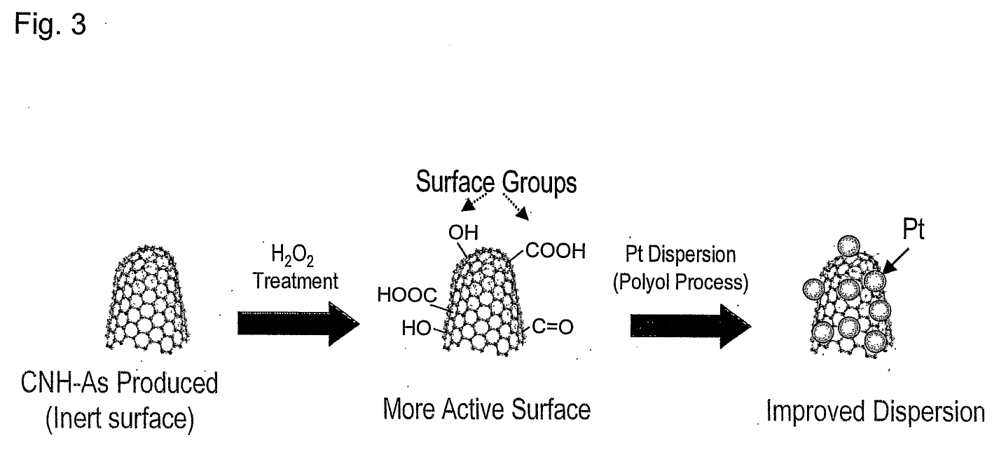

In the present invention, to facilitate supporting of the catalytic metal on the carbon nanohorn aggregate support and application of the polyelectrolyte, preferably the carbon nanohorn aggregate is pretreated with a hydrogen peroxide solution. FIG. 3 is a schematic view of the pretreatment of a carbon nanohorn aggregate with a hydrogen peroxide solution and a polyol process using ethylene glycol following the pretreatment. As FIG. 3 shows, various surface groups are produced on the surface of carbon nanohorns by the pretreatment with the hydrogen peroxide solution. When a catalytic metal such as platinum is dispersed in the presence of polyol, dispersion of the catalytic metal is facilitated on the surface of carbon nanohorns due to the presence of such surface groups.

Pretreatment of carbon nanohorn aggregates with a hydrogen peroxide solution is technically advantageous in that (1) the hydrogen peroxide solution does not break the carbon nanohorn structure, (2) the hydrogen peroxide solution oxidizes and removes amorphous impurities in carbon nanohorns, and (3) surface groups such as a hydroxyl group, a carboxylic acid group and a carbonyl group are produced on the surface of carbon nanohorns by pretreating with the hydrogen peroxide solution as shown in FIG. 3.

Since ethylene glycol (EG) has small surface tension, it adheres to the surface of carbon nanohorns in the form of droplets. Introduction of a Pt salt solution thereto induces a reducing reaction in a one step process. More specifically, dehydration occurs and acetaldehyde is formed and acetaldehyde reduces Pt(II) to Pt, forming diacetyl.

Next, the process for producing a catalyst electrode for a fuel cell of the present invention is described. The catalytic metal is supported on the carbon nanohorn aggregate by a commonly used impregnation method. In the method, a catalytic substance formed into colloid by dissolving or dispersing metal salt of the catalytic metal in a solvent is supported on the carbon nanohorn aggregate and then subjected to reduction treatment. Reduction treatment at room temperature to 130° C. or higher makes it possible to form catalytic metal supported on the surface of the carbon nanohorn aggregate into relatively large spherical particles having an average particle size of 3.2 nm or more. Further, the catalytic metal can be uniformly dispersed on the carbon nanohorn particles. Then, carbon particles on which the catalyst is supported and polyelectrolyte particles are dispersed in a solvent to form a paste, and then the paste is applied to a substrate and dried to give a catalyst electrode for a fuel cell.

The carbon nanohorn aggregate may also be used after being supported on carbon fiber, carbon nanofiber or carbon nanotube by heat treatment. With this treatment, fine structures of catalyst layers can be optionally controlled.

The method of applying paste to the substrate is not particularly limited, and methods such as brush coating, spray coating and screen printing can be used. The paste is applied in a thickness of, for example, about 1 μm to 2 mm. After applying the paste, heating is performed at a temperature and for a period of time appropriate for the fluorine resin to be used to prepare a fuel electrode or an oxidant electrode. The heating temperature and the heating time are accordingly selected depending on the materials to be used. For example, the heating temperature is 100° C. to 250° C. and the heating time is 30 seconds to 30 minutes.

In the following, application of the electrode catalyst for a fuel cell of the present invention to a fuel cell is described. In a solid polymer fuel cell, a solid electrolyte film has a role of separating the anode and the cathode and transferring hydrogen ions and water molecules between the two. For this reason, it is preferred that the solid electrolyte film has high hydrogen ion conductivity. It is also preferred that the solid electrolyte film is chemically stable and has high mechanical strength.

As the material constituting the solid electrolyte film, an organic polymer containing a polar group such as a strong acid group including a sulfone group, a phosphate group, a phosphonic group and a phosphine group or a weak acid group including a carboxyl group is preferably used. Examples of such organic polymers include aromatic group-containing polymers such as sulfonated poly(4-phenoxybenzoyl-1,4-phenylene) and alkylsulfonated polybenzimidazole, polystyrene sulfonic acid copolymers, polyvinylsulfonic acid copolymers, crosslinked alkylsulfonic acid derivatives, copolymers such as fluorine-containing polymers composed of a fluorine resin skeleton and sulfonic acid, copolymers obtained by copolymerization of acrylamide such as acrylamide-2-methylpropane sulfonic acid and acrylate such as n-butyl methacrylate, sulfone group-containing perfluorocarbon (Nafion® available from DuPont, Aciplex available from Asahi Kasei Corporation), and carboxyl group-containing perfluorocarbon (Flemion® S film available from ASAHI GLASS CO., LTD.).

For fuels fed to the fuel cell, gas fuels or liquid fuels may be used. When using a gas fuel, hydrogen, for example, can be used. When using a liquid fuel, for example, alcohols such as methanol, ethanol and propanol, ethers such as dimethylether, cycloparaffins such as cyclohexane, cycloparaffins containing a hydrophilic group such as a hydroxyl group, a carboxyl group, an amino group or an amide group and monosubstituted or disubstituted cycloparaffins can be used as an organic compound contained in the fuel. Herein, cycloparaffins refer to cycloparaffins and substituted cycloparaffins, and those other than the aromatic compounds are used.

In the solid polymer fuel cell thus obtained, carbon nanohorn aggregates are used as catalyst-supporting carbon particles. Since the catalytic metal 2 is not supported in deep regions between carbon nanohorns, and in particular, the catalytic metal supported on the surface of the carbon nanohorn aggregate is spherical and has an average particle size of 3.2 to 4.6 nm, the solid polymer fuel cell has high utilization efficiency of the catalyst and excellent battery properties.

### Examples

In the following, the catalyst electrode for a fuel cell and the fuel cell using the same according to the present invention are described in more detail with reference to Examples, but the present invention is not limited thereto.

### Example 1

High purity carbon nanohorns were prepared and chloride, nitride and/or organic compounds of Pt, Rh, Co, Cr, Fe, Ni were prepared as metal sources. Ethylene glycol was prepared as polyol.

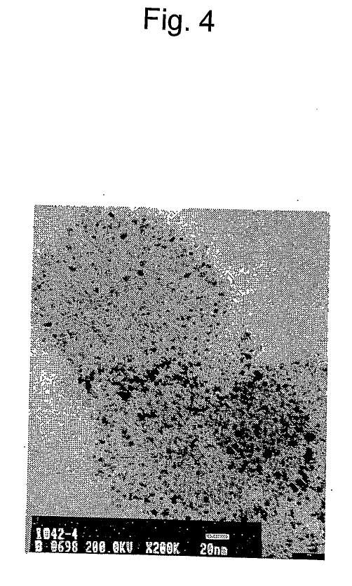

The carbon nanohorn sample was pretreated with a hydrogen peroxide solution to activate the surface. The catalytic metal was supported on the support through a polyol process using polyol having low surface tension. The amount supported of platinum was set to 46% Pt/CNH and thus Pt has an average particle size of 2.8 nm. The reduction temperature was 140° C. and the reduction time was 8 hours. After filtration and drying, baking was performed in inert gas at 100° C. as a post-treatment. The resulting electrode catalyst was formed into ink by a conventional method and coating was performed by a cast method to prepare a catalyst layer of MEA. A TEM photograph was taken and the active Pt area and the O₂ reduction current of the product were measured by a rotating disk electrode (RDE) method. The TEM photograph is shown in FIG. 4.

By setting the reduction temperature to 160° C., an average particle size of Pt of 3.5 nm was obtained, and by setting the reduction temperature to 180° C., an average particle size of Pt of 4.5 nm was obtained. The results show that the average particle size of Pt can be controlled by the reduction temperature. It has also been found that the average particle size of Pt increases as the reduction time is set to 8 hours, 12 hours and 16 hours. Further, an average particle size of Pt of 2.8 nm was obtained at a baking temperature of 100° C., an average particle size of Pt of 4.9 nm at a baking temperature of 200° C., an average particle size of Pt of 5.2 nm at a baking temperature of 300° C., and an average particle size of Pt of 5.6 nm at a baking temperature of 400° C. The results show that the average particle size of Pt can be controlled by the baking temperature.

The active Pt area of the product was 0.34 cm²/μg·Pt and the O₂ reduction current was 0.087 A/mg·Pt as measured by the rotating disk electrode (RDE) method.

### Example 2

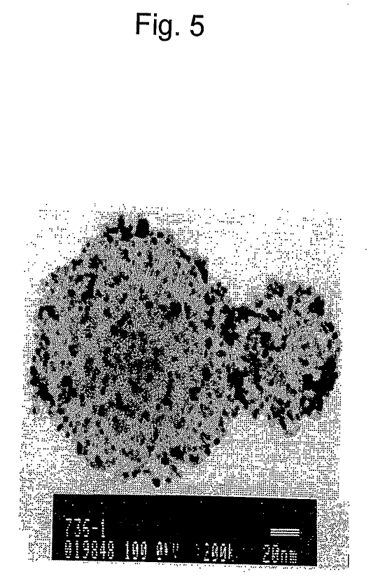

Experiments were performed in the same manner as in Example 1 except that the amount supported of platinum was set to 60% Pt/CNH and thus Pt has an average particle size of 3.5 nm. A TEM photograph was taken and the active Pt area and the O₂ reduction current of the product were measured by the rotating disk electrode (RDE) method. The TEM photograph is shown in FIG. 5.

The active Pt area of the product was 0:38 cm²/μg·Pt and the O₂ reduction current was 0.110 A/mg·Pt as measured by the rotating disk electrode (RDE) method.

### Example 3

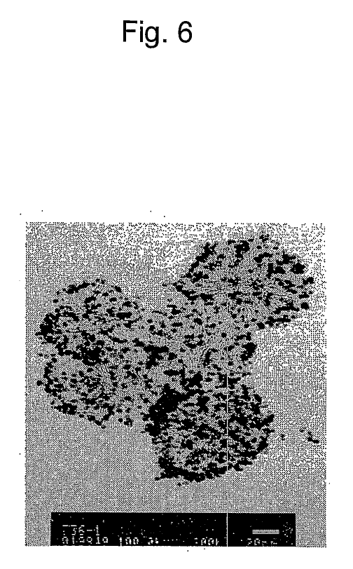

Experiments were performed in the same manner as in Example 1 except that the amount supported of platinum was set to 70% Pt/CNH and thus Pt has an average particle size of 4.8 nm. A TEM photograph was taken and the active Pt area and the O₂ reduction current of the product were measured by the rotating disk electrode (RDE) method. The TEM photograph is shown in FIG. 6.

The active Pt area of the product was 0.27 cm²81 g·Pt and the O₂ reduction current was 0.105 A/mg·Pt as measured by the rotating disk electrode (RDE) method.

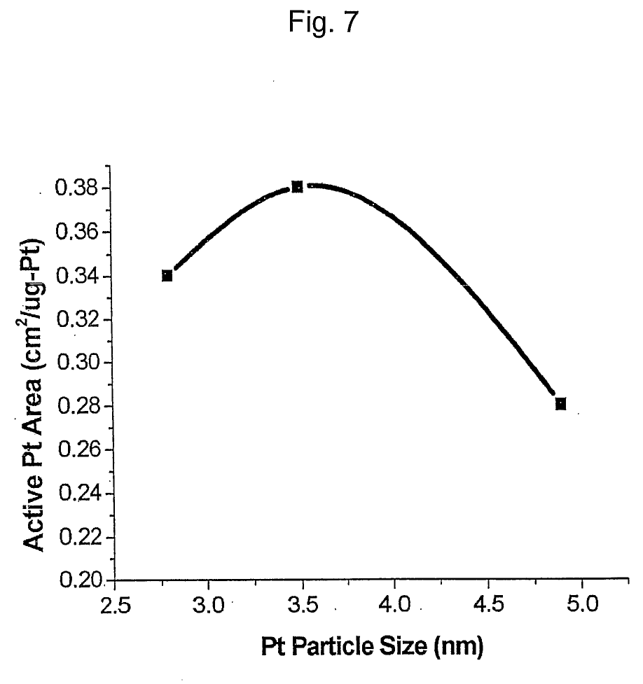

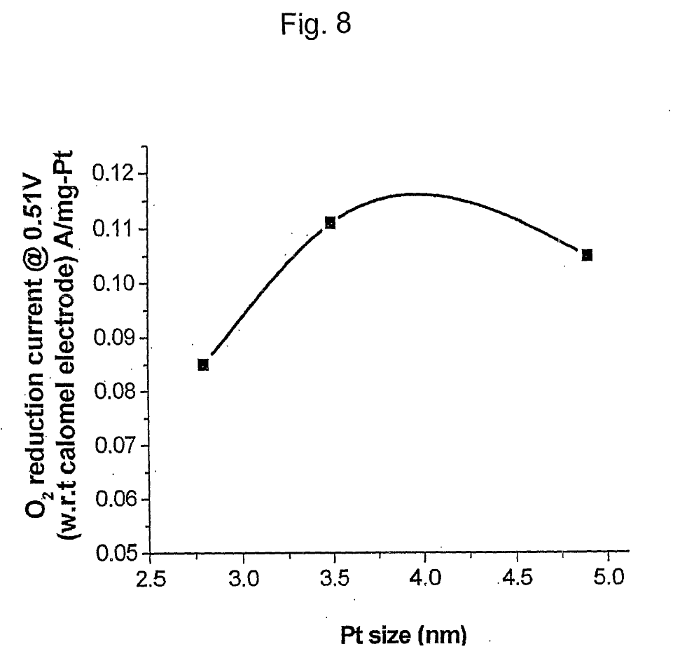

FIG. 7 shows the relationship between average particle sizes of Pt and active Pt areas obtained in Examples 1 to 3. Likewise, FIG. 8 shows the relationship between average particle sizes of Pt and O₂ reduction currents obtained in Examples 1 to 3.

The results in FIG. 7 and FIG. 8 show that excellent catalytic ability is exhibited when the catalytic metal has an average particle size of 3.2 to 4.6 nm.

### INDUSTRIAL APPLICABILITY

The present invention makes it possible to form sufficient three phase interfaces on the surface of tips and middle portions of carbon nanohorns and thus even a small amount of the catalytic metal can be efficiently used for the reaction. As herein described, the utilization rate of the catalyst increases and the power generation efficiency is improved even if the amount of materials are the same. Accordingly, the support with a catalyst according to the present invention can be applied to a wide range of catalysts using a carbon support, and in particular, can be preferably applied to electrodes for a fuel cell, and contributes to extended uses of fuel cells.

1. An electrode catalyst for a fuel cell, comprising a carbon nanohorn aggregate as a support, a catalytic metal supported on the carbon nanohorn aggregate support and a polyelectrolyte applied to the carbon nanohorn aggregate support, characterized in that the catalytic metal is not supported in deep regions between carbon nanohorns.

2. The electrode catalyst for a fuel cell according to claim 1, characterized in that the catalytic metal has an average particle size of 3.2 to 4.6 nm.

3. A process for producing an electrode catalyst for a fuel cell, comprising a carbon nanohorn aggregate as a support, a catalytic metal supported on the carbon nanohorn aggregate support and a polyelectrolyte applied to the carbon nanohorn aggregate support,
the process comprising the steps of:
dispersing a salt of the catalytic metal in a solvent,
adding the carbon nanohorn aggregate thereto,
reducing, filtering and drying the mixture under heating, and
applying the polyelectrolyte to the resulting catalytic metal-supporting carbon nanohorn aggregate.

4. The process for producing an electrode catalyst for a fuel cell according to claim 3, characterized in that the catalytic metal has an average particle size of 3.2 to 4.6 nm.

5. The process for producing an electrode catalyst for a fuel cell according to claim 3 or 4, characterized in that the average particle size of the catalytic metal is controlled based on a supporting ratio of the catalytic metal supported on the carbon nanohorn aggregate, a reduction temperature, a reduction time and or combination of two or more of them.

6. The process for producing an electrode catalyst for a fuel cell according to claim 5, characterized in that the supporting ratio of the catalytic metal supported on the carbon nanohorn aggregate is 45 to 70%.

7. The process for producing an electrode catalyst for a fuel cell according to claim 5, characterized in that the reduction temperature is 130 to 180° C.

8. The process for producing an electrode catalyst for a fuel cell according to claim 5, characterized in that the reduction time is 8 to 16 hours.

9. The process for producing an electrode catalyst for a fuel cell according to any one of claims 3 to 8, characterized in that the carbon nanohorn aggregate is pretreated with a hydrogen peroxide solution.

10. A solid polymer fuel cell comprising an anode, a cathode and a polyelectrolyte film disposed between the anode and the cathode, characterized in that the anode and/or the cathode comprise the electrode catalyst for a fuel cell according to claim 1 or 2.
